(19) United States
(12) Patent Application Publication
(10) Pub. No.: US 2012/0296786 A1
(43) Pub. Date: Nov. 22, 2012

(54) ACCOUNT RESERVE

(75) Inventors: Alexander Azariy Shenkar, Roswell, GA (US); Erik Stephen Ross, Charlotte, NC (US)

(73) Assignee: Bank of America Corporation, Charlotte, NC (US)

(21) Appl. No.: 13/110,165

(22) Filed: May 18, 2011

(51) Int. Cl. G06Q 40/00

(52) U.S. Cl. 705/35

(57) ABSTRACT

Embodiments of the invention are directed to systems, methods and computer program products for managing an account. In some embodiments, a method includes receiving information associated with an account. The method further includes determining, based at least partially on the information, a selected amount of currency from the account to hold in a reserve associated with the account and indicating the selected amount of currency to hold in the reserve. In some embodiments, the selected amount of currency is determined based at least partially on determining one or more eligible transactions from a transaction history associated with the account. In some embodiments, an eligible transaction may be a recurring transaction such as a rent payment transaction, a utilities payment transaction, etc.

### BACKGROUND

Financial institution customers are constantly looking for new and useful ways to mitigate or eliminate the hassles associated with managing their finances, particularly those associated with making (and remembering to make) account payments. This is particularly so given that most of today's financial institution customers have multiple financial accounts and the consequences associated with improperly making and/or missing a payment on any one of them. Accordingly, there is a need to provide methods and apparatuses that help financial institution customers better manage their accounts.

### BRIEF SUMMARY

The following presents a simplified summary of several embodiments of the invention in order to provide a basic understanding of such embodiments. This summary is not an extensive overview of all contemplated embodiments of the invention, and is intended to neither identify key or critical elements of all embodiments, nor delineate the scope of any or all embodiments. Its purpose is to present some concepts of one or more embodiments in a simplified form as a prelude to the more detailed description that is presented later.

Embodiments of the present invention address the above needs and/or achieve other advantages by providing apparatuses (e.g., a system, computer program product, and/or other device), methods, or a combination of the foregoing for managing an account.

For instance, a method is provided for managing an account. In some embodiments, the method includes receiving at a computing device information associated with the account. The method further includes determining, via a computing device processor, a selected amount of currency from the account to hold in a reserve associated with the account, based at least partially on the information. The method further includes indicating the selected amount of currency to hold in the reserve. In some embodiments, the selected amount of currency is determined based at least partially on determining one or more recurring transactions from a transaction history associated with the account. One or more of the steps of the method described herein may be executed via a processor such as a computing device processor.

Embodiments of the invention also provide an apparatus for performing each of the above embodiments of the method. The apparatus includes a computing platform including at least one processor and a memory. The apparatus also includes a module, or more than one module, stored in the memory, executable by the processor, and configured to execute the various embodiments of the method described above.

Embodiments of the invention also provide a computer program product for performing each of the above embodiments of the method. The computer program product includes a non-transitory computer-readable medium including a set of codes for causing a computer to execute the various embodiments of the method described above.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the present invention in general terms, reference will now be made to the accompanying drawings, wherein:

FIG. 1 is a flow diagram illustrating a general process flow of a system for managing currency in an account, in accordance with embodiments of the present invention;

FIG. 2 is another flow diagram illustrating a process flow of a system for managing currency in an account, in accordance with embodiments of the present invention;

FIG. 3 is a block diagram illustrating technical components of a system for managing currency in an account, in accordance with an embodiment of the present invention.

FIG. 4 is an example user interface of an account reserve service associated with an account, in accordance with an embodiment of the present invention; and

FIG. 5 is another example user interface of an account reserve service associated with an account, in accordance with an embodiment of the present invention.

### DETAILED DESCRIPTION OF EMBODIMENTS OF THE PRESENT INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

Various embodiments or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

In general, embodiments of the present invention relate to systems, methods and computer program products for managing currency in an account using a reserve, where the reserve holds currency associated with an account. In some embodiments, the currency in the reserve may be used to satisfy recurring transactions (rent, utilities, mortgage payment, etc.) and/or other eligible transactions. In at least one embodiment, the invention is configured to help a user manage the user's account so that the account has sufficient currency to meet these recurring transactions.

For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. An “account” may be the relationship that an individual or a first entity such as a business organization, hereinafter referred to as the “user” or “client” or “consumer” or “account holder,” has with a second entity, which may be a financial institution. As used herein, a “user” may be someone other than an “account holder” who operates the account's holder's account. For instance, this account may be a deposit account, such as a transactional account (e.g., a checking account), a savings account, a money market account, a time deposit, a demand deposit, a brokerage account, a home equity loan, a media network account, a social network account, etc. This account could also be a credit account such that the account holder has a repayment or delivery obligation towards a second entity under previously agreed upon terms and conditions. In some embodiments, the account may hold monetary currency (e.g., funds and/or credit), while in other embodiments the account may hold non-monetary currency (e.g., number of points or credits associated with a media network account or a social network account). In some embodiments, the account may hold real currency (e.g., real funds and/or credit that can be used to purchase a good or service), while in other embodiments, the account may hold virtual currency (e.g., points or virtual funds and/or virtual credit that can be redeemed on a social network or a media network based on one or more rules associated with the social network or the media network). A “transaction” may be monetary in nature (e.g., a purchase using credit associated with a credit account or using funds in a deposit account; depositing a deposit item, e.g., a check, in an account; requesting a credit or cash advance; a stock trade or the like) or non-monetary in nature (e.g., a telephone call; an encounter with a financial institution or non-financial institution associate/representative; an identity authentication process, such as a biometric identity authentication process; recorded use of a utility, such as electricity and the like).

In accordance with embodiments of the invention, the term “module” with respect to a system may refer to a hardware component of the system, a software component of the system, or a component of the system that comprises both hardware and software.

In accordance with embodiments of the invention, a “reserve” is a store of currency. As used herein, funds or credit are mere examples of some types of currency. The reserve is associated with an account. In some embodiments, the reserve is part of the account, while in other embodiments, the reserve is associated with the account, but not part of the account. In some embodiments, a selected amount of currency from the account is transferred (e.g., periodically transferred) to the reserve. The currency in the reserve is locked and may only be released to satisfy eligible transactions (e.g., recurring transactions such as rent, utilities, mortgage payment, etc.) that meet one or more conditions. Therefore, for example, the reserve helps a user to manage eligible transactions that need to be satisfied in the future by locking a selected amount of currency associated with an account to meet these transactions. In some embodiments, the invention helps a user manage the user's account so that the account has sufficient currency to meet these eligible transactions. In some embodiments, there may be one or more reserves associated with a single account. In some embodiments, the reserve may be a separate account in itself. In some embodiments, the reserve may be managed by a financial institution different from the financial institution that manages the account.

In some embodiments, the reserve may be further classified as a “soft reserve” or a “hard reserve.” A “hard” reserve is a reserve that does not allow a user to manually transfer currency into or out of the reserve unless one or more conditions (e.g., the transaction needs to be recurring, needs to of a certain transaction type, etc.) are satisfied for transfer of currency into or out of the reserve. Therefore, a hard reserve only releases currency for transactions that satisfy one more conditions for release of currency from the reserve. For instance, the hard reserve may release currency to meet transactions that are of a certain type (e.g., mortgage payment) or that are associated with amounts greater than a certain amount (e.g., $1000). Moreover, a user cannot transfer currency into a hard reserve even if the amount of currency remaining in the reserve is insufficient to satisfy one or more transactions that are eligible to be satisfied using currency from the reserve. A “soft” reserve is a reserve that allows a user to manually transfer currency into (or out of) of the reserve regardless of whether one or more conditions are satisfied for transfer of currency into or out of the reserve.

In some embodiments, the currency associated with the “non-reserve” portion of an account is released to satisfy transactions that do not meet conditions that prompt an apparatus to release currency from the reserve. As used herein, a “non-reserve” associated with the account is that part of the account that stores currency not associated with the reserve. In some embodiments, in addition to a reserve and a non-reserve, an account may include a floor reserve. The floor reserve may include currency that is always available, but is not used as a source of payment to meet a transaction unless there are unforeseen circumstances. A list of these unforeseen circumstances may be programmed into a software application associated with an apparatus (e.g., an account management system) such that currency is released from the floor reserve if the apparatus determines that a condition for an unforeseen circumstance is met. In some embodiments, a user may not be allowed access to the currency in the floor reserve at the point of making a transaction if the transaction does not meet one or more conditions that are classified as unforeseen circumstances. In some embodiments, a user may be allowed access to the currency in the floor reserve when the user is managing the user's account via a computing device.

In some embodiments, a reserve may be associated with a social network. In such embodiments, a group of users may contribute currency to a single reserve (or multiple reserves). Each user may make an equal or unequal contribution to the reserve. The users may collectively decide upon one or more conditions upon which a user may withdraw currency from the reserve. In some embodiments, if the user engages in a transaction that meets one of the conditions, the user may withdraw currency from the reserve. In such embodiments, the user may withdraw an amount from the reserve greater than the amount of currency that the user contributed to the reserve. In some embodiments, the users may collectively decide upon a maximum amount that a single user may withdraw from the reserve. In some embodiments, the user may withdraw an amount from the reserve if the user obtains permission from a predetermined number of users that contributed to the reserve. Additionally or alternatively, the user may withdraw an amount from the reserve if the user obtains permission from a predetermined number of other connections on the user's social network, where the other connections are not contributors to the reserve. These other connections may be able to objectively decide whether the user should be allowed to withdraw currency from the reserve. In some embodiments, these other connections may be directly connected to the user on the social network, or indirectly connected to the user on the social network (the indirect connections may be connected to the user via one or more other connections).

In some embodiments, a reserve may be associated with a small business or entity. In such embodiments, a group of founders of the entity may contribute currency to a single reserve (or multiple reserves). Alternatively, a group of employees of the entity may set up a reserve to hold a predetermined amount of currency associated with the entity. The founders or employees may decide upon one or more qualifying conditions that a transaction has to meet in order for the transaction to be satisfied using currency from the reserve.

### High-Level Process Flow

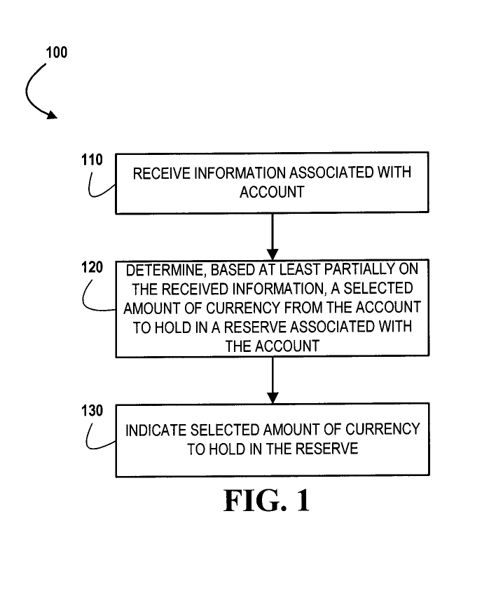

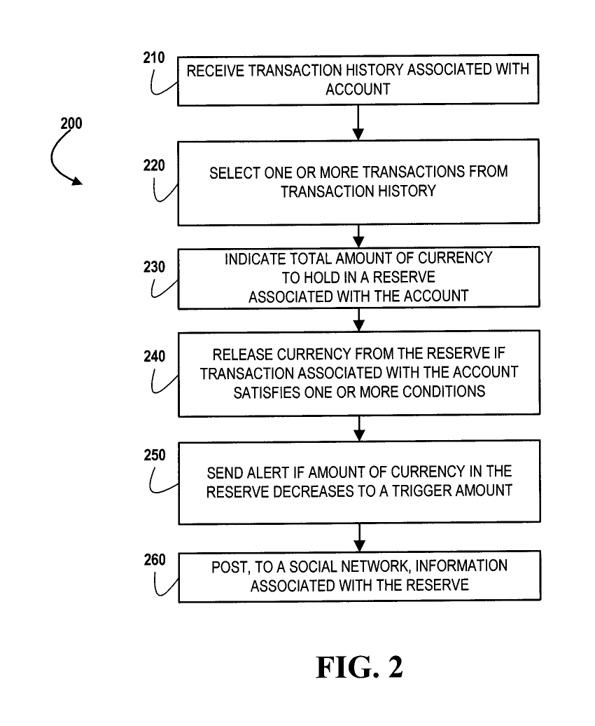

FIG. 1 is a high-level flowchart for managing an account using a reserve, where the reserve holds currency associated with an account, in accordance with embodiments of the present invention. In some embodiments, the process flow 100 starts at block 110 where an apparatus receives information associated with the account. In some embodiments, the apparatus includes a memory and a processor. As used with respect to FIG. 1, an “apparatus” may either be an account management system 330 or a user interface system 320. The received information associated with the account will be described in further detail below. In some embodiments, the account may be an electronic banking account (e.g., online deposit or credit account, mobile deposit or credit account, etc.). In some embodiments, the received information associated with the account may include the transaction history associated with the account. The transaction history is described in further detail with respect to FIG. 2.

The process flow then moves to block 120 where the apparatus determines, based at least partially on the received information, a selected amount of currency from the account to hold in a reserve associated with the account. The process by which the apparatus determines the selected amount of currency will be described with respect to FIG. 2. The process flow then moves to block 130 where the apparatus indicates the selected amount of currency (determined at block 120) to hold in the reserve associated with the account. Alternatively, at block 130, the apparatus causes the reserve to hold the selected amount of currency.

Moreover, with respect to FIG. 1, a first process block may be performed after a second process block even though FIG. 1 indicates that the second process block is performed after the first process block. For instance, blocks 120 and 130 may be performed before block 110, even though FIG. 1 indicates that block 110 is performed before blocks 120 and 130.

In some embodiments, the apparatus having the process flow 100 can be configured to perform any one or more portions of the process flow 100 represented by blocks 110-130 upon or after one or more triggering events, which, in some embodiments, is one or more of the other portions of the process flow 100. As used herein, it will be understood that a “triggering event” refers to an event that automatically triggers the execution, performance, and/or implementation of a triggered action, either immediately, nearly immediately (i.e., within minutes), or sometime after the occurrence of the triggering event. For example, in some embodiments, the apparatus is configured such that the apparatus receiving the information (the triggering event) automatically and immediately triggers the apparatus to determine, based at least partially on the received information, a selected amount of currency from the account to hold in a reserve associated with the account (the triggered action). In some embodiments, the apparatus is additionally or alternatively configured to indicate (e.g., to another apparatus) the selected amount of currency to hold in the reserve associated with the account (triggered action) simultaneous with or sometime after (e.g., minutes after, hours after, etc.) determining a selected amount of currency from the account to hold in the reserve (triggering event).

In some embodiments, a predetermined time and/or the passage of a predetermined period of time may serve to trigger one or more of the portions represented by blocks 110-130. Also, in some embodiments, the apparatus is configured to automatically perform one or more (or all) of the portions of the process flow 100 represented by blocks 110-130. In other embodiments, one or more (or all) of the portions of the process flow 100 represented by blocks 110-130 require and/or involve at least some human intervention. In addition to the process flow 100, any of the embodiments described and/or contemplated herein can involve one or more triggering events, triggered actions, automatic actions, apparatus actions, and/or human actions. Further, it will be understood that one or more portions of the process flow 100 can occur at any time with respect to the status of the transaction referred to in block 110. For example, in some embodiments, the apparatus is configured to perform one or more portions of the process flow 100 after the transaction is initiated and/or after the transaction is authorized but before the transaction is finalized.

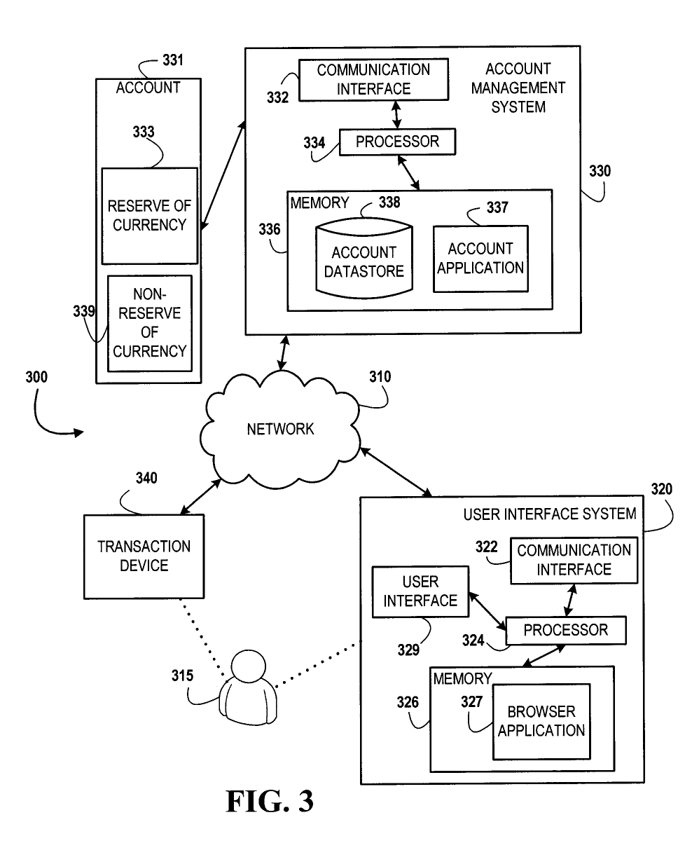

It will also be understood that the apparatus having the process flow 100 can be configured to perform any one or more portions of any embodiment described and/or contemplated herein, including, for example, any one or more portions of the process flow 200 described later herein. In some embodiments, the account management system 330 performs one or more of the process blocks of FIG. 1. In another embodiment, a user interface system 320, rather than an account management system 330, performs one or more of the process blocks of FIG. 1. The account management system 330 and the user interface system 320 are described in further detail in subsequent sections with respect to FIG. 3. In addition, the number, order, and/or content of the portions of the process flow 100 are exemplary and may vary. Indeed, the process flow 100, like all of the other process flows described herein, can include one or more additional and/or alternative process flow portions, and the apparatus configured to perform the process flow 100 can be configured to perform one or more additional and/or alternative functions.

### Detailed Process Flow

FIG. 2 is a detailed flowchart displaying a process 200 for managing an account using a reserve, where the reserve holds currency associated with an account. With respect to FIG. 2, a first process block may be performed after a second process block even though FIG. 2 indicates that the second process block is performed after the first process block. For instance, block 220 may be performed before block 210, even though FIG. 2 indicates that block 220 is performed after block 310.

In some embodiments, the account management system 330 performs one or more of the process blocks of FIG. 2. In another embodiment, a user interface system 320, rather than an account management system 330, performs one or more of the process blocks of FIG. 2. Therefore, as used with respect to FIG. 2, an “apparatus” may either be an account management system 330 or a user interface system 320. The account management system 330 and the user interface system 320 are described in further detail in subsequent sections with respect to FIG. 2.

The account management system 330 and/or the user interface system 320 have hardware and/or software configured to perform one or more process blocks of the process flow 200. Each of these apparatuses can include one or more communication interfaces, processors, memory devices, user interfaces, image capture devices, applications, and/or datastores, as previously described herein. In addition, in an example embodiment, the user interface system 320 is a computing device that is remotely located from, but is operatively connected to (e.g., via one or more networks), the account management system 330.

The process flow starts at block 210 where an apparatus receives a transaction history associated with an account. This transaction history may include one or more transactions associated with an account, where the one or more transactions were executed within a predetermined period of time in the past (e.g., previous six months). As explained above, a “transaction” may be monetary in nature (e.g., a purchase using credit associated with a credit account; a purchase using funds associated with a deposit account; depositing a deposit item, e.g., a check, in an account; requesting a credit or cash advance; a stock trade or the like) or non-monetary in nature (e.g., a telephone call; an encounter with a financial institution or non-financial institution associate/representative; an identity authentication process, such as a biometric identity authentication process; recorded use of a utility, such as electricity and the like). In some embodiments, as an alternative or in addition to receiving the transaction history, the apparatus receives digital receipts associated with transactions that are satisfied using currency from the account. These digital receipts may comprise information including the type of transaction, the amount associated with the transaction, the payee, the date of the transaction, etc. In some embodiments, the apparatus receives transaction histories associated with more than one account, where some of the accounts may be managed by a financial institution different from the financial institution that manages the user's account.

The process flow then moves to block 220 where the apparatus, in some embodiments, determines one or more transactions associated with the account. In some embodiments, the apparatus presents data associated with the account to the user. This account data may include the transaction history associated with the account. In some embodiments, the apparatus allows a user to select one or more transactions from the transaction history in order to determine the amount of currency to hold in the reserve.

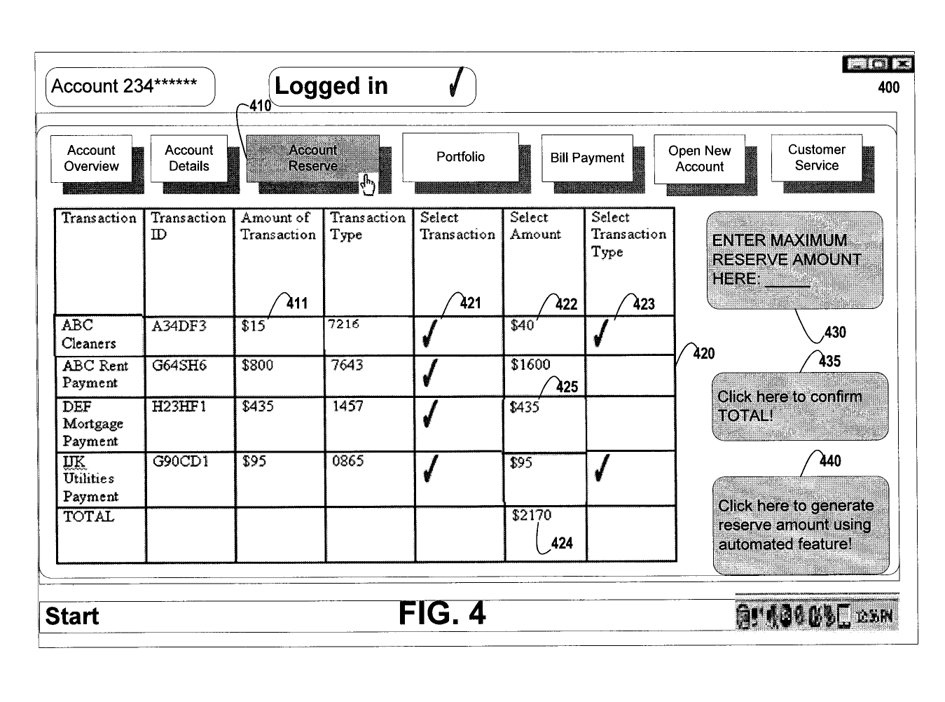

The user may be able to select one or more transactions from the transaction history (see FIG. 4). If a transaction selected by the user occurs in the future, the apparatus may cause the transaction to be satisfied using currency from the reserve. For instance, a user may select a transaction for $15 at “ABC Cleaners”. If a user executes the same transaction (i.e., $15 at “ABC Cleaners”) again in the future, the apparatus may cause the transaction to be satisfied using currency from the reserve. In another instance, if the future transaction at “ABC Cleaners” is for $10 only, the apparatus may still cause the transaction to be satisfied using currency from the reserve. In another instance, if the future transaction at “ABC Cleaners” is for $20, the apparatus may cause $15 of the transaction to be satisfied using currency from the reserve, and may cause $5 of the transaction to be satisfied using currency from the non-reserve. In an alternate embodiment, if the future transaction at “ABC Cleaners” is for $20, the apparatus may cause the entire $20 to be satisfied using currency from the non-reserve. In still another alternative embodiment, if the future transaction at “ABC Cleaners” is for $20, the apparatus may cause $15 of the transaction to be satisfied using currency from the reserve, and the financial institution that manages the user's account satisfies the remaining $5 of the transaction by issuing an overdraft.

In some embodiments, the user may not only be able to select one or more transactions from the transaction history, but for each selected transaction, the user may also be able to define a number of instances of a selected transaction that will be satisfied using currency from the reserve. For instance, a user may select a transaction for $15 at “ABC Cleaners” and the user may additionally select three instances as the number of instances for which currency from the reserve will be used to satisfy the transaction. Therefore, the apparatus may subsequently hold $45 in the reserve. Subsequently, when the user executes the same transaction (i.e., $15 at “ABC Cleaners”) on three occasions in the future, the apparatus may cause the three transactions to be satisfied using currency in the reserve. When the user executes the same transaction (i.e., $15 at “ABC Cleaners”) on the fourth occasion in the future, the apparatus may cause the fourth transaction to be satisfied using currency from the non-reserve. Alternatively, the apparatus may not cause the fourth transaction to be satisfied using currency from the non-reserve; instead, the financial institution that manages the account may issue an overdraft to satisfy the fourth transaction.

In some embodiments, the user may not only be able to select one or more transactions from the transaction history, but the user may also be able to define an amount associated with the selected transaction to hold in the reserve. For instance, a user may select a transaction at “ABC Cleaners” and further define an amount of $40 associated with that transaction. Therefore, if the user executes a future transaction at “ABC Cleaners” for $10, the apparatus may cause the entire transaction to be satisfied using currency from the reserve. If the user executes a next subsequent transaction at “ABC Cleaners” for $35, the apparatus causes the first $30 of the transaction to be satisfied using currency from the reserve and causes the next $5 of the transaction to be satisfied using currency from the non-reserve. If the user executes a second subsequent transaction after the first subsequent transaction at “ABC Cleaners” for $10, the apparatus causes the entire transaction to be satisfied using currency from the non-reserve. In an alternate embodiment, the apparatus does not cause the second subsequent transaction to be satisfied using currency from the non-reserve; instead, the second subsequent transaction at “ABC Cleaners” for $10 is satisfied using overdraft currency (e.g., funds) issued by the financial institution that manages the user's account.

In alternate embodiments, a user may select a transaction for $15 at “ABC Cleaners” and not select an amount associated with the selected transaction to hold in the reserve. In such embodiments, rather than holding $15 of currency in the reserve, the apparatus may analyze the transaction history. The apparatus may determine from the transaction history that the largest transaction associated with “ABC Cleaners” was $30 during a predetermined period (e.g., six months or one year). The apparatus may subsequently cause the reserve to hold $30 of currency. Alternatively, the apparatus may determine from the transaction history that the average of the transactions associated with “ABC Cleaners” was $25 during a predetermined period (e.g., six months or one year). The apparatus may subsequently cause the reserve to hold $30 of currency.

In some embodiments, the user may be able to define or select a transaction type (e.g., merchant category code) associated with transactions to be satisfied using currency from the reserve. For instance, a user may select a transaction of $15 at “ABC Cleaners” and may select an option to indicate to the apparatus that any similar transactions (i.e., dry cleaner transactions) may be satisfied using currency from the reserve. In some embodiments, the apparatus may classify each transaction using a particular code. In some embodiments, this particular code may be part of a code assignment process designed by the financial institution that manages the user's account. In other embodiments, this particular code may be a merchant category code. The merchant category code may be a code (e.g., a four digit number) assigned to a merchant or a business. The merchant category code may be used to classify merchants or businesses by the type of goods and/or services they provide. For instance, the merchant category code associated with dry cleaners is 7216. Therefore, when the apparatus determines that a user has executed a transaction associated with merchant category code number 7216 in the future, the apparatus causes the transaction to be satisfied using currency from the reserve.

Alternatively, the user may, in addition to selecting an option to indicate to the apparatus that dry cleaner transactions be satisfied using currency from the reserve, further define an amount of currency (e.g., $40) to hold in the reserve to satisfy such transactions. For instance, the user may select on a user interface an option that dry cleaner transactions be satisfied using currency from the reserve and further define an amount of $40 to hold in the reserve in order to satisfy such dry cleaner transactions. Therefore, if the user executes a dry cleaner transaction at any merchant for $10, the apparatus will cause the entire transaction to be satisfied using currency from the reserve. If the user executes a first subsequent dry cleaner transaction for $35, the apparatus may cause the first $30 of the transaction to be satisfied using currency from the reserve. The apparatus may cause the next $5 of the transaction to be satisfied using currency from the non-reserve. If the user executes a second subsequent dry cleaner transaction after the first subsequent dry cleaner transaction at any merchant for $10, the apparatus causes the entire transaction to be satisfied using currency from the non-reserve. In an alternate embodiment, the apparatus does not cause the second subsequent transaction to be satisfied using currency from the non-reserve; instead, the second subsequent transaction at “ABC Cleaners” for $10 is satisfied using overdraft currency (e.g., funds) issued by the financial institution that manages the user's account.

In some embodiments, the user may be able to define or select a transaction location, where if the transaction occurs at the transaction location, the transaction may be satisfied using currency from the reserve. In some embodiments, a location may be defined as a particular store (e.g., ABC Supermarket) regardless of where the store is located. In other embodiments, a location may be defined as a particular store at a particular location (e.g., ABC Supermarket at 9^{th} Ave). In still other embodiments, a location may be defined in terms of the distance from a reference point (e.g., 5 miles radius or 5 miles driving distance from home or workplace).

In some embodiments, the user may be able to define a set of discretionary (e.g., buying a high-end music system) and nondiscretionary (e.g., monthly rent) transactions, where if the transaction is a non-discretionary transaction, the transaction may be satisfied by the apparatus using currency from the reserve. In other embodiments, the user may be able to define a set of discretionary and nondiscretionary transactions, where if the transaction is a discretionary transaction, the transaction may be satisfied by the apparatus using currency from the reserve. In some embodiments, the apparatus may be automatically programmed to identify discretionary and nondiscretionary transactions based at least partially on the transaction history associated with the user.

In other embodiments, the apparatus may automatically select one or more transactions from the transaction history based at least partially on one or more conditions of eligibility. Therefore, the apparatus may allow a user to select an option on an interface (e.g., see FIG. 4), where selecting the option causes an apparatus to automatically define an amount of currency to hold in the reserve based at least partially on the apparatus determining or identifying one or more transactions that are eligible to be satisfied using currency from the reserve. A transaction may be eligible to be satisfied using currency from the reserve if the transaction satisfied one or more condition. In some embodiments, a first condition may be that the transaction needs to be a recurring transaction.

In some embodiments, the apparatus may select one or more recurring transactions that have recurred during a predetermined period of time. In some embodiments, a “recurring” transaction is a transaction (e.g., monetary transaction) that was satisfied periodically using currency from the account. In some embodiments, a “recurring” transaction need not have been satisfied periodically, but is a transaction that was satisfied on at least a predetermined number of occasions over a certain period of time (e.g., at least five times during the previous six months, or e.g., greater than four times but less than seven times during the previous six months) using currency from the account. In some embodiments, a recurring transaction may be a nondiscretionary expense associated with an account. For instance, a recurring transaction may be a monthly rent payment that was satisfied using currency from the account. Therefore, if the apparatus determines that a rent payment of $800 was made every month during the previous six months, the apparatus may cause the reserve to hold $800 of currency. Therefore, if the user executes a subsequent rent payment for $800, the apparatus may cause the rent payment transaction to be satisfied using currency from the reserve. In some embodiments, the apparatus may recognize the rent payment transaction as the transaction that needs to be satisfied using currency from the reserve using an identifier associated with the payee (e.g., name of payee, merchant number associated with payee, etc.). Alternatively, the apparatus may recognize the rent payment transaction by the amount of the transaction (e.g., $800).

As another instance, a recurring transaction may be a monthly utilities payment that is satisfied using currency from the account. Here, the apparatus may determine that the highest utilities payment made during the previous six months was $103, and may therefore cause the reserve to hold $103 of currency. Therefore, if the user executes a utilities payment transaction for $103 or lower, the apparatus may cause the transaction to be satisfied using currency from the reserve. If the user executes a utilities payment transaction for $110, the apparatus may cause the first $103 to be satisfied using currency from the reserve, and the apparatus may cause the remaining $7 to be satisfied using currency from the non-reserve. Alternatively, the apparatus may not cause the remaining $7 to be satisfied using currency from the reserve. Instead, the remaining $7 may be satisfied using overdraft currency (e.g., funds) issued by the financial institution that manages the user's account.

Alternatively, the apparatus may determine that the average utilities payment made during a predetermined period of time (e.g., the previous six months) was $95, and may therefore cause the reserve to hold $95 of currency. Therefore, if the user executes a utilities payment transaction for $95 or lower, the apparatus may satisfy transaction using currency from the reserve. If the user executes a utilities payment transaction for $110, the apparatus may cause the first $95 to be satisfied using currency from the reserve, and the apparatus may cause the remaining $15 to be satisfied using currency from the non-reserve. Alternatively, the apparatus may not cause the remaining $15 to be satisfied using currency from the non-reserve. Instead, the remaining $15 may be satisfied using overdraft currency (e.g., funds) issued by the financial institution that manages the user's account.

As described above, in default embodiments, for a transaction selected by the apparatus, the apparatus may cause a reserve to hold currency to satisfy the next instance of the selected transaction. However, for each selected transaction, the apparatus may be configured to hold a greater amount of currency in the reserve in order to satisfy more than one instance of the selected transaction. For instance, assume the above embodiment where the apparatus selects a utilities transaction as a transaction for which the reserve holds currency, and further assume that the average utilities transaction made during the previous six months was $95. In this embodiment, the apparatus may be configured to cause the reserve to hold $190 of currency in order to satisfy the next two instances of a utilities transaction. Moreover, for a different selected transaction such as a rent payment transaction, the apparatus may be configured to cause the reserve to hold an amount of currency associated with the next three instances of the rent payment transaction.

In some embodiments, an apparatus may extract recurring transactions from an account's participation in a financial institution's electronic bill payment service, if an account participates in the bill payment service. As used herein, an electronic bill payment service is a service offered by a financial institution that allows a user of an account to transfer currency from the account to a creditor or vendor such as a public utility company or a retail store to be credited against the account. Financial institutions may allow users of the service to schedule such transfers (and in some cases, recurring transfers) in advance of the due date so that currency is automatically transferred to the creditor or vendor on the date specified by the user. For instance, a user may, using a bill payment service, schedule a monthly utilities payment to be automatically satisfied using currency from the account. The apparatus may subsequently determine an amount of currency to hold in the reserve using information from the account's participation in the bill payment service. The amount of currency to hold in the reserve may be defined according to the embodiments described above. When the apparatus determines that a utilities transaction has been executed by the user, the apparatus may cause the transaction to be satisfied using currency from the reserve.

In some embodiments, a transaction may have to satisfy one or more conditions in order for an apparatus to automatically select the transaction as a transaction for which the reserve holds currency. For instance, the apparatus may be configured to automatically select one or more transactions associated with a predetermined transaction code (e.g., merchant category code). For instance, the apparatus may be configured to automatically select utilities transactions, and the apparatus may be configured to not select rent payment transactions. As another instance, the apparatus may be configured to automatically select one or more transactions that meet a certain minimum transaction amount.

In some embodiments, an apparatus selects one or more, but not all, of the recurring transactions from the transaction history. Alternatively, an apparatus selects partial amounts associated with recurring transactions. This is because, in some embodiments, a user may define an absolute maximum amount (e.g., $1000) of currency to hold in the reserve or a percentage of the account (e.g., 20%) to hold in the reserve, or even a particular percentage of a selected transaction to hold in the reserve. In some embodiments, the apparatus may automatically define a predetermined absolute maximum amount (e.g., $10000) that a user may contribute to the reserve over a certain period of time (e.g., one year). In these embodiments, this maximum amount may be determined by the financial institution, and the reserve account may function similar to a 401(k) account that also has a maximum contribution limit per year. In order to comply with the maximum amount of currency that the reserve may hold, the apparatus may automatically select the transactions that satisfy one or more of the above conditions (e.g., the transaction is a recurring transaction, the transaction is associated with a merchant category code, etc.) and may subsequently allocate a proportion of the reserve amount to each transaction. For instance, if the apparatus selects three transactions of $400 each for which the reserve holds currency and if the maximum amount of currency that the reserve may hold is $1000, then each transaction may be eligible to be satisfied with up to $333 of the reserve currency. Alternatively, in some embodiments, in order to comply with the maximum amount of currency that the reserve may hold, the apparatus may cause the reserve to hold currency that can be used to entirely satisfy some transactions, while other transactions may be satisfied partially or may not be satisfied at all. For instance, if the apparatus selects three transactions of $400 each (e.g., rent transaction of $400, mortgage transaction of $400, and utilities transaction of $400) for which the reserve may hold currency and if the maximum amount of currency that the reserve may hold is $1000, then the first transaction that occurs (e.g., rent transaction of $400) may be satisfied in full using currency from the reserve. The second transaction that occurs (e.g., mortgage transaction of $400) may also be satisfied in full using currency from the reserve. The next transaction that occurs (e.g., utilities transaction of $400) may only be satisfied using the remaining $200 from the reserve. The remaining $200 of the utilities transaction may be satisfied using currency from the non-reserve. Alternatively, in other embodiments, the apparatus does not cause the remaining $200 of the utilities transaction to be satisfied using currency from the non-reserve; instead, the remaining $200 is satisfied using overdraft currency (e.g., funds) issued by the financial institution that manages the user's account.

Thus, in some embodiments, the apparatus may 1) analyze the transaction history associated with the account, 2) automatically select or determine one or more eligible transactions for which the reserve may hold currency, where eligibility is based at least partially on one or more of the above described conditions, and 3) subsequently cause the reserve to hold an amount of currency so that the reserve amount satisfies at least one subsequent instance of a selected transaction.

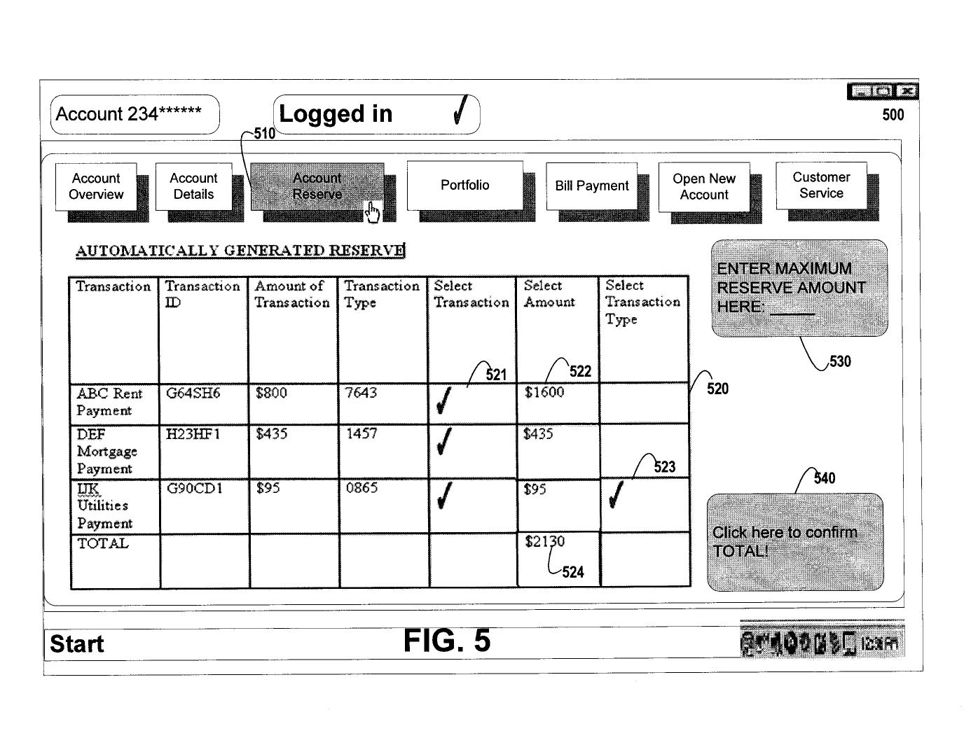

In other embodiments, the apparatus may 1) analyze the transaction history associated with the account, 2) automatically select or determine one or more eligible transactions for which the reserve may hold currency, where eligibility is based at least partially on one or more of the above described conditions, and 3) subsequently allow a user to confirm the apparatus' selection of a transaction or deselect an apparatus' selection of a transaction. FIG. 5, which is also discussed later, presents an example interface that shows an embodiment where the apparatus allows a user to confirm the apparatus' selection of a transaction or deselect an apparatus' selection of a transaction. As shown in FIG. 5, the apparatus presents the total amount of currency to hold in the reserve based on the transactions selected by the apparatus. If the user deselects a particular transaction, the total amount presented in FIG. 5 is dynamically updated on the interface to reflect the de-selection of the particular transaction, i.e., the total is reduced by an amount associated with the particular transaction.

The process flow then moves to block 230 where the apparatus indicates the total amount of currency to hold in the reserve. In some embodiments, this total is the amount of currency to hold in the reserve as defined by the user. In other embodiments, this total may be the amount of currency that corresponds to eligible transactions as determined or selected by the user at block 220. In still other embodiments, this total may be the amount of currency that corresponds to eligible transactions automatically selected by the apparatus at block 220. Alternatively or additionally, at block 230, the apparatus causes the reserve to hold the total amount of currency. In some embodiments, the apparatus may determine that the total amount of currency to hold in the reserve is greater than a predetermined maximum amount that the reserve can hold. This maximum amount may either be defined by the user (the apparatus may prompt the user to define the maximum amount) or may be defined by the entity (e.g., financial institution) that manages the reserve. In such embodiments, the apparatus may automatically invest the excess amount of currency in a money market account or some other liquid currency account. A user may be able to use this excess amount for purposes or transactions as determined by the user (e.g., investing, saving for retirement, death in the family, marriage, loss of employment, etc.).

Alternatively, the apparatus may cause the total amount of currency to be retained in the account, but is designated as ‘reserve’ currency. Alternatively, the apparatus may cause the total amount of currency to be transferred to a separate ‘reserve’ account. In some embodiments, an apparatus may comprise more than one reserve. Each reserve may correspond to reserve currency associated with a selected transaction. Therefore, a first reserve may comprise currency that may be used to satisfy one or more instances of a utilities transaction, and a second reserve may comprise currency that may be used to satisfy one or more instances of a rent payment transaction.

In some embodiments, the apparatus may periodically (e.g., once every six months) 1) analyze the transaction history associated with the account, 2) automatically select or determine one or more eligible transactions for which the reserve may hold currency, where eligibility is based at least partially on one or more of the above described conditions, and 3) subsequently cause the reserve to hold an amount of currency so that the reserve amount may satisfy at least one subsequent instance of a selected transaction. By periodically executing these steps, the apparatus may be able to identify new transactions that meet the one or more conditions that cause the reserve to hold currency. Also the apparatus may be able to identify transactions that no longer meet the one or more conditions that causes the reserve to hold currency (e.g., a mortgage has been satisfied in full and therefore, the apparatus does not need to cause the reserve to hold currency in order to make a mortgage payment). Also, by periodically executing the steps, the apparatus may be able to identify an updated amount of currency to hold in the reserve for transactions that meet the one or more conditions.

In some embodiments, the apparatus may automatically determine that an expected transaction for which the reserve holds currency has not occurred. For instance, an apparatus may determine that a rent payment transaction, which is usually executed by the user by the last date of each month during a predetermined period of time (e.g., the previous six months), has not occurred. Since the rent payment transaction has not occurred by the last date of the month, the apparatus may automatically release the currency that the reserve holds so that that currency may be used for other purposes. Therefore, in some embodiments, the released currency may become part of the non-reserve.

In some embodiments, the apparatus may automatically alter, based at least partially on one or more events, an amount of currency that the reserve holds for a selected transaction. For example, in one embodiment, as described above, the apparatus may determine that the average utilities payment made during the previous six months was $95, and may therefore cause the reserve to hold $95 of currency. Now assume that the apparatus determined that the current utilities payment transaction is $90. First, the apparatus causes the $90 transaction to be satisfied using currency from the reserve. Next, the apparatus recalculates the average of the utilities payment transaction over the preceding six months (this average may have changed because of the new six moth period that is considered). Assume that the apparatus determines that the average utilities payment is now $96. Since the reserve already comprises the remaining $5 that is designated for a utilities payment transaction, therefore, the apparatus may cause $91 to be moved from the non-reserve to the reserve. Therefore, the apparatus automatically alters, based at least partially on the current transaction, an amount of currency that the reserve holds. In other embodiments, the apparatus automatically alters an amount of currency that the reserve holds based at least partially on one or more rules or conditions that are programmed into a software application associated with the apparatus.

In some embodiments, the apparatus may allow a user to alter, with or without reason, the amount of currency that the reserve holds. In some embodiments, the apparatus may also allow a user to select or deselect, with or without reason, the transactions that may be satisfied using currency from the reserve.

In some embodiments, the apparatus may be configured to not release currency from the reserve for a predetermined period of time (e.g., during a particular month). Therefore, during this predetermined period, if a user executes a transaction that is eligible to be satisfied using currency from the reserve, the apparatus does not cause currency to be released from the reserve to satisfy the transaction. Instead, the apparatus may cause currency to be released from the non-reserve to satisfy the transaction.

In some embodiments, a software application associated with the apparatus allows a user to create a “personal” contract. As part of this contract, the user may select one or more conditions for which the reserve currency can be used. For instance a condition may be a loss of employment. Therefore, if the user loses employment in the future, the apparatus allows release of currency from the reserve. Another condition may be graduation from college. Therefore, when such a condition is established, the apparatus may only allow release of currency from the reserve when the user graduates from college.

The process flow then moves to block 240 where the apparatus receives a request to release currency associated with an account in order to meet a transaction (e.g., a user makes an online payment via a payment card associated with the account). If the transaction is an eligible transaction, i.e., the transaction satisfies the one or more conditions defined at block 230, then the apparatus may cause currency to be released from the reserve in order to satisfy the transaction. If the transaction is not an eligible transaction, i.e., the transaction does not satisfy the one or more conditions defined at block 230, then the apparatus may not cause currency to be released from the reserve in order to satisfy the transaction. In some embodiments, if the transaction is not an eligible transaction, i.e., the transaction does not satisfy the one or more conditions defined at block 230, then the apparatus may cause currency to be released from the non-reserve in order to satisfy the transaction.

In some embodiments, the apparatus may be configured to release currency from the reserve only during a predetermined period of time (e.g., during particular days of a month or a particular block of days during a month). Therefore, during this predetermined period, if a user executes a transaction that is eligible to be satisfied using currency from the reserve, the apparatus may cause currency to be released from the reserve to satisfy the transaction. If, outside this predetermined period, the user executes a transaction that is eligible to be satisfied using currency from the reserve, the apparatus may not cause currency to be released from the reserve to satisfy the transaction. Therefore, outside the predetermined period, the apparatus may cause currency to be released from the non-reserve to satisfy the transaction.

In some embodiments, the apparatus may prompt the user to rank the one or more eligible transactions, i.e., the transactions selected by the user or automatically selected by the apparatus based on one or more selection criteria. In other embodiments, the apparatus may automatically rank the one or more eligible transactions. In order to determine whether to release currency from the reserve to satisfy a transaction, the apparatus may consider the ranking associated with the transaction. For instance, if the reserve has funds sufficient to satisfy only a single transaction between two competing eligible transactions, the apparatus may release currency from the reserve to satisfy only the higher ranked transaction. The apparatus may release currency from the non-reserve to satisfy the lower ranked transaction. As a further instance, if the currency available in the reserve falls below a certain threshold (e.g., falls below $1000), the apparatus may be configured to satisfy, using currency from the reserve, transactions that are associated with rankings greater than a certain ranking (e.g., greater than a ranking of 5).

In some embodiments, in response to receiving a request to release currency associated with an account to meet a transaction, the apparatus may always be configured to release currency from the non-reserve regardless of the nature or type of transaction. At a later point in time (e.g., at the time of settlement), the apparatus may determine whether the transaction was an eligible transaction, i.e., the transaction was selected by the user or automatically selected by the apparatus based on or more selection criteria. In some embodiments, the apparatus may determine periodically (e.g., once a day at 10 PM) whether any transaction that was executed during the day (from 12 AM to 10 PM) was an eligible transaction. If the apparatus determines that the transaction is an eligible transaction, the transaction transfers, from the reserve to the non-reserve, the amount of currency that was released to meet the transaction.

The process flow then moves to block 250 where the apparatus sends an alert to a user, system, or the like if the amount of currency in the reserve decreases to a trigger amount. This alert may be sent via one or more communication methods, e.g., email, short message service (SMS), voice, or the like. In some embodiments, the trigger amount is pre-determined by the user; in other embodiments, the trigger amount is dynamically determined by the apparatus. For instance, the apparatus may dynamically determine that the amount of currency remaining in the reserve is sufficient to satisfy only the next predicted transaction that is eligible to be satisfied using currency from the reserve, but the remaining amount is not sufficient to satisfy any transactions after the next predicted eligible transaction. In another instance, the apparatus may dynamically determine that the amount of currency remaining in the reserve is insufficient to even satisfy the next predicted transaction that is eligible to be satisfied using currency from the reserve. In both instances, the apparatus may automatically send an alert to a user, system, or the like.

In another embodiment, the trigger amount is a specific percentage of the amount of currency in the reserve. When the amount of currency in the reserve decreases to this specific percentage, the apparatus automatically sends an alert via the communication methods described above. In still another embodiment, the trigger amount is a specific percentage of the amount of currency in the non-reserve. In still another embodiment, the trigger amount is a specific percentage of the total amount of currency in the account.

In some embodiments, when the amount of currency in the reserve decreases to a trigger amount, the apparatus automatically transfers currency from the non-reserve to the reserve. For instance, the apparatus automatically transfers currency from the non-reserve to the reserve when the apparatus dynamically determines that the currency remaining in the reserve is insufficient to satisfy the next predicted transaction that is eligible to be satisfied using currency from the reserve. In some embodiments, when the amount of currency in the reserve decreases to a trigger amount, the apparatus may 1) analyze the transaction history associated with the account, 2) automatically select or determine one or more eligible transactions for which the reserve may hold currency based at least partially on one or more of the above described conditions, and 3) subsequently cause the reserve to hold an amount of currency so that the reserve amount satisfies at least one subsequent instance of a selected transaction.

In other embodiments, an apparatus allows a user to transfer currency into and out of the reserve (or into and out of the non-reserve) regardless of whether one more conditions to release currency from the reserve (or non-reserve) are satisfied.

In some embodiments, when the amount of currency in the reserve decreases to a trigger amount, the apparatus does not automatically transfer currency from the non-reserve to the reserve. Additionally or alternatively, when the amount of currency in the reserve decreases to a trigger amount, the apparatus does not allow a user to transfer currency from the non-reserve to the reserve. In such embodiments, when an amount associated with a transaction that is eligible to be satisfied using currency from the reserve is greater than the amount of currency remaining in the reserve, then the transaction is satisfied using currency from the non-reserve. In alternate embodiments, when an amount associated with a transaction that is eligible to be satisfied using currency from the reserve is greater than the amount of currency remaining in the reserve, then an overdraft occurs, and the financial institution may satisfy the transaction using the financial institution's currency, and in turn, the financial institution may assess a fee against the account.

The process flow then moves to block 260 where the apparatus posts the alert generated at block 250 to a social network associated with the user. In some embodiments, the apparatus automatically posts the alert to a social network. In other embodiments, the apparatus generates a prompt for the user so that the user can choose to either post or not post the alert to a social network. When the alert is posted to a social network, the user's contacts on the user's social network may be able to view the alert. Over time, one or more alerts that are posted to the user's social network (and are visible to the user's contacts) may encourage the user to decrease the number of and/or amount associated with transactions that need to be satisfied using currency from the reserve.

### System and Environment

Referring now to FIG. 3, a system 300 for managing an account using a reserve, where the reserve holds currency associated with an account, in accordance with an embodiment of the present invention. As illustrated, the system 300 includes a network 310, a user interface system 320, an account management system 330, and a transaction device 340. FIG. 3 also illustrates an account 331, which could be a credit account (e.g., a credit card account, a HELOC account, etc.) and/or a deposit account (e.g., a checking account, a savings accounts, etc.), both of which are operatively connected (e.g., linked) to the account management system 330, as well as to each other. Also shown in FIG. 3 is a user 315 that has access to the user interface system 320 and the transaction device 340. In this embodiment, the user interface system 320 is maintained by the user 315, the transaction device 340 is maintained by a merchant (not shown), and the account management system 330, along with the account 331, the reserve 333, and the non-reserve 339 are maintained by a single financial institution (not shown) for the benefit of the user 315. It will also be understood that the user 315 may use the account 331 to make one or more purchases from the merchant by using the transaction device 340.

As shown in FIG. 3, the user interface system 320, the account management system 330, and the transaction device 340 are each operatively and selectively connected to the network 310, which may include one or more separate networks. In addition, the network 310 may include a local area network (LAN), a wide area network (WAN), and/or a global area network (GAN), such as the Internet. It will also be understood that the network 310 may be secure and/or unsecure and may also include wireless and/or wireline technology.

The user interface system 320 may include any computerized apparatus that can be configured to perform any one or more of the functions of the user interface system 320 described and/or contemplated herein. In some embodiments, for example, the user interface system 320 may include a personal computer system, a mobile device, a smart phone, a personal digital assistant, an e-book reader, a public kiosk, a network device, and/or the like. As illustrated in FIG. 3, in accordance with some embodiments of the present invention, the user interface system 320 includes a communication interface 322, a processor 324, a memory 326 having a browser application 327 stored therein, and a user interface 329. In such embodiments, the communication interface 322 is operatively and selectively connected to the processor 324, which is operatively and selectively connected to the user interface 329 and the memory 326.

Each communication interface described herein, including the communication interface 322, generally includes hardware, and, in some instances, software, that enables a portion of the system 300, such as the user interface system 320, to transport, send, receive, and/or otherwise communicate information to and/or from the communication interface of one or more other portions of the system 300. For example, the communication interface 322 of the user interface system 320 may include a modem, server, electrical connection, and/or other electronic device that operatively connects the user interface system 320 to another electronic device, such as the electronic devices that make up the account management system 330.

Each processor described herein, including the processor 324, generally includes circuitry for implementing the audio, visual, and/or logic functions of that portion of the system 300. For example, the processor may include a digital signal processor device, a microprocessor device, and various analog-to-digital converters, digital-to-analog converters, and other support circuits. Control and signal processing functions of the system in which the processor resides may be allocated between these devices according to their respective capabilities. The processor may also include functionality to operate one or more software programs based at least partially on computer-executable program code portions thereof, which may be stored, for example, in a memory device, such as in the browser application 327 of the memory 326 of the user interface system 320.

Each memory device described herein, including the memory 326 for storing the browser application 327 and other data, may include any computer-readable medium. For example, memory may include volatile memory, such as volatile random access memory (RAM) having a cache area for the temporary storage of data. Memory may also include non-volatile memory, which may be embedded and/or may be removable. The non-volatile memory may additionally or alternatively include an EEPROM, flash memory, and/or the like. The memory may store any one or more of pieces of information and data used by the system in which it resides to implement the functions of that system.

As shown in FIG. 3, the memory 326 includes the browser application 327. In some embodiments, the browser application 327 includes a web browser and/or some other application for communicating with, navigating, controlling, configuring, and/or using the account management system 330 and/or other portions of the system 300. For example, in some embodiments, the user 315 uses the browser application 327 to trigger and/or configure one or more aspects of the account management system 330 that relate to a reserve associated with an account. For example, in some embodiments, the user 315 uses the browser application 327 to determine a selected amount of currency to hold in the reserve. As another example, in some embodiments, the user 315 uses the browser application 327 to select one or more financial transaction associated with the account, where the reserve holds amounts associated with the selected financial transactions. As another example, in some embodiments, the user 315 uses the browser application 327 to define an amount associated with a selected financial transaction, and select a number of instances of the financial transaction to be satisfied using currency from the reserve. As another example, in some embodiments, the user 315 uses the browser application 327 to alter a selected amount of currency that the reserve currently holds. As still another example, in some embodiments the user 315 uses the browser application 327 to view information associated with an account, including the transaction history associated with an account (and to view one or more recurring transactions associated with an account). As still another example, in some embodiments the user 315 uses the browser application 327 to view information associated with one or more reserves and/or non-reserves associated with the account. As still another example, in some embodiments the user 315 uses the browser application 327 to post information associated with a reserve and/or an account to a social network associated with the user. As still another example, in some embodiments, the user 315 uses the browser application 327 to transfer currency from a reserve to a non-reserve associated with an account, and from the reserve to the non-reserve. As still another example, in some embodiments the user 315 uses the browser application 327 to lock currency for a predetermined period of time in the reserve. As still another example, in some embodiments the user 315 uses the browser application 327 to define one or more events or conditions that define when currency can be released from a reserve. In some embodiments, the user 315 uses the browser application 327 to define a time period, or a set of time periods, or a set of recurring time periods, or the like that define when currency can be released from the reserve. In some embodiments, the user 315 uses the browser application 327 to define a transaction type (e.g., merchant category code) associated with a transaction that defines when currency may be released from the reserve to satisfy the amount of the transaction. In some embodiments, the user 315 uses the browser application 327 to access an online and/or mobile banking account 331 for configuring these one or more aspects of the account management system 330. In some embodiments, the browser application 327 includes computer-executable program code portions for instructing the processor 324 to perform one or more of the functions of the browser application 327 described and/or contemplated herein. In some embodiments, the browser application 327 may include and/or use one or more network and/or system communication protocols.

Also shown in FIG. 3 is the user interface 329. In some embodiments, the user interface 329 includes one or more user output devices, such as a display and/or speaker, for presenting information to the user 315 and/or some other user. In some embodiments, the user interface 329 includes one or more user input devices, such as one or more buttons, keys, dials, levers, directional pads, joysticks, accelerometers, controllers, microphones, touchpads, touchscreens, haptic interfaces, microphones, scanners, motion detectors, cameras, televisions, gaming devices, and/or the like for receiving information from the user 315 and/or some other user. In some embodiments, the user interface 329 includes the input and display devices of a personal computer, such as a keyboard and monitor, that are operable to receive and display information associated with the reserve associated with the account.

FIG. 3 also illustrates an account management system 330, in accordance with an embodiment of the present invention. The account management system 330 may include any computerized apparatus that can be configured to perform any one or more of the functions of the account management system 330 described and/or contemplated herein. In accordance with some embodiments, for example, the account management system 330 may include a computer network, an engine, a platform, a server, a database system, a front end system, a back end system, a personal computer system, and/or the like. In some embodiments, such as the one illustrated in FIG. 3, the account management system 330 includes a communication interface 332, a processor 334, and a memory 336, which includes an account application 337 and an account datastore 338 stored therein. As shown, the communication interface 332 is operatively and selectively connected to the processor 334, which is operatively and selectively connected to the memory 336.

It will be understood that the account application 337 can be configured to implement any one or more portions of any one or more of the process flows 100 and/or 200 described and/or contemplated herein. For example, in some embodiments, the account application 337 is configured to link the reserve 333 to the account 331. Alternatively, the account application 337 is configured to create the reserve 333 from the currency in the account 331. As another example, in some embodiments, the account application 337 is configured to receive information associated with the account 331 (e.g., receive transaction history associated with the account 331). As another example, in some embodiments, the account application 337 is configured to automatically analyze the transaction history of the account 331 for purposes of determining a selected amount of currency to hold in the reserve 333. As another example, in some embodiments, the account application 337 is configured to automatically determine, based at least partially on the received information, a selected amount of currency from the account 331 to hold in the reserve 333 associated with the account 331 (e.g., the account application 337 is configured to determine sum of one or more eligible (e.g., recurring) transactions from transaction history associated with the account 331). As another example, in some embodiments, the account application 337 is configured to determine an average amount (or a maximum amount) associated with one or more instances of an eligible financial transaction during a predetermined period of time. As another example, in some embodiments, the account application 337 is configured to determine that an amount associated with the eligible financial transaction may satisfy one or more instances of the eligible financial transaction. As another example, in some embodiments, the account application 337 is configured to determine that an eligible financial transaction is of a particular transaction type (e.g., merchant category code). As another example, in some embodiments, the account application 337 is configured to proportionately decrease an amount associated with an eligible financial transaction based at least partially on a predetermined maximum amount of currency that the reserve 333 may hold. As another example, in some embodiments, the account application 337 is configured to automatically alter the selected amount to hold in the reserve 333 based at least partially on determining a change in the one or more eligible financial transactions.

As another example, in some embodiments, the account application 337 is configured to hold the selected amount of currency in the reserve 333 associated with the account 331 (e.g., hold, in the reserve 333, sum of one or more eligible (e.g., recurring) transactions determined from transaction history associated with the account 331). As another example, in some embodiments, the account application 337 is configured to indicate the selected amount of currency to hold in the reserve 333 associated with the account 331. As another example, in some embodiments, the account application 337 is configured to prompt a user to determine the selected amount and/or receive a user's selection of the selected amount, or receive a user's selection of transactions and other related data associated with the selected transactions (e.g., amount associated with each selected transaction, transaction type associated with each selected transaction, etc.). As another example, in some embodiments, the account application 337 is configured to prompt a user to select an amount from a list of amounts to hold in the reserve as generated by the account application 337. As another example, in some embodiments, the account application 337 is configured to send an alert when an amount of currency in the reserve 333 decreases to a predetermined percentage of the selected amount. As another example, in some embodiments, the account application 337 is configured to send an alert when an amount of currency in the reserve 333 decreases to a trigger amount. As another example, in some embodiments, the account application 337 is configured to post, to a social network, information associated with the reserve 333. As another example, in some embodiments, the account application 337 is configured to post, to a social network, the above-described alert. As another example, in some embodiments, the account application 337 is configured to allow a user 315 to transfer currency from the reserve 333 to a non-reserve 339 associated with the account 331 (or from the non-reserve 339 to the reserve 333). As another example, in some embodiments, the account application 337 is configured to automatically transfer currency from the non-reserve 339 to the reserve 333 if an amount of currency in the reserve 333 decreases to a pre-determined amount. As another example, in some embodiments, the account application 337 is configured to allow a user 315 to create a separate reserve account that holds the reserve currency. As another example, in some embodiments, the account application 337 is configured to lock currency in the reserve 333 for a period of time either predetermined by the user 315 or automatically determined by the account application 337. As another example, in some embodiments, the account application 337 is configured to release currency from the reserve 333 if a transaction satisfies one or more conditions (e.g., the transaction is recurring, the transaction is associated with a selected transaction type, the transaction is associated with an account's bill pay feature, etc.). As another example, in some embodiments, the account application 337 is configured to release currency from the reserve 333 during one or more predetermined periods as determined by the user 315 or as determined automatically by the account application 337. As another example, in some embodiments, the account application 337 is configured to release currency from the reserve 333 when a transaction is made by a user that corresponds to a transaction type (e.g., merchant category code) as predetermined by the user or automatically determined by the account application 337.

It will also be understood that, in some embodiments, the account application 337 is additionally configured to provide other kinds of financial services. For example, in some embodiments, the account application 337 may be operable to process financial transactions involving the account 331 and/or the reserve 333 and the non-reserve 339. In some cases, this function is performed alongside one or more of the steps described and/or contemplated herein that relate to making a determination as to whether a payment or monetary transaction may be satisfied using currency from a reserve 333 or a non-reserve 339 associated with an account. For example, where the user 315 attempts to make a purchase with the account 331 at the transaction device 340, the account application 337 may be configured to approve a payment request from the transaction device 340, as well as simultaneously (or sometime thereafter) determine that the transaction qualifies as a transaction that may satisfied using currency from the reserve 333, and therefore, the payment request may be satisfied, either entirely or partially, by a payment using currency from the reserve 333. As another example, in some embodiments, the account application 337 is configured to provide online and/or mobile banking services to the user 315 at the user interface system 320, such as, for example, any of the online and/or mobile banking services described and/or contemplated herein.

It will also be understood that, in some embodiments, the account application 337 is configured to communicate with the account datastore 338, the user interface system 320, the transaction device 340, and/or any one or more other portions of the system 300. For example, in some embodiments, the account application 337 is configured to send payment authorization information to, and/or receive transaction data from, the transaction device 340. As another example, in some embodiments, the account application 337 is configured to create and/or send one or more notifications to the user 315 at the user interface system 320 that explain, for example, that the payment for the transaction has been made using currency from the reserve 333 associated with the account 331, or from a non-reserve 339 associated with the account.

It will be further understood that, in some embodiments, the account application 337 includes computer-executable program code portions for instructing the processor 334 to perform any one or more of the functions of the account application 337 described and/or contemplated herein. In some embodiments, the account application 337 may include and/or use one or more network and/or system communication protocols.

In addition to the account application 337, the memory 336 also includes the account datastore 338. In some embodiments, the account datastore 338 includes information associated with one or more financial accounts (e.g., the account 331, the reserve 333, the non-reserve 339, one or more non-financial institution accounts (not shown), etc.), including, for example, account names, persons and/or entities associated with the financial accounts, addresses associated with the financial accounts, transaction data and/or transaction history associated with the financial accounts, whether one or more financial account are linked to one or more other financial accounts, and/or any other type and/or amount of information. In some embodiments, the account datastore 338 may also store any information relating to determining, recommending, and/or executing a strategy for establishing a selected amount of currency that the reserve 333 may hold, and establishing one or more conditions and/or rules that define how the reserve's 333 currency are to be released from the reserve 333. In some embodiments, the account datastore 338 stores information associated with online and/or mobile banking.

It will be understood that the account datastore 338 may include any one or more storage devices, including, but not limited to, datastores, databases, and/or any of the other storage devices typically associated with a computer system. It will also be understood that the account datastore 338 may store information in any known way, such as, for example, by using one or more computer codes and/or languages, alphanumeric character strings, data sets, figures, tables, charts, links, documents, and/or the like. Further, in some embodiments, the account datastore 338 may include information associated with one or more applications, such as, for example, the account application 337. It will also be understood that, in some embodiments, the account datastore 338 provides a substantially real-time representation of the information stored therein, so that, for example, when the processor 334 accesses the account datastore 338, the information stored therein is current or substantially current.

It will be understood that the embodiment illustrated in FIG. 3 is exemplary and that other embodiments may vary. As another example, in some embodiments, the account management system 330 includes more, less, or different components, such as, for example, an account manager user interface.

As another example, in some embodiments, some or all of the portions of the system 300 may be combined into a single portion. Specifically, in some embodiments, the user interface system 320 and the account management system 330 are combined into a single user interface and account management system configured to perform all of the same functions of those separate portions as described and/or contemplated herein. Likewise, in some embodiments, some or all of the portions of the system 300 may be separated into two or more distinct portions. Specifically, in some embodiments, the account management system 330 may be separated into a financial account datastore system configured to store and/or manage transaction data associated with the account, and a reserve datastore system configured to store and/or manage transaction data with the reserve.

In addition, the various portions of the system 300 may be maintained for by the same or separate parties. For example, as previously mentioned, a single financial institution may maintain the account 331, the reserve 333, and the account management system 330. However, in other embodiments, the account 331, the reserve 333, and the account management system 330 may each be maintained by separate entities.

It will also be understood that the system 300 may include and/or implement any embodiment of the present invention described and/or contemplated herein. For example, in some embodiments, the system 300 is configured to implement any one or more of the embodiments of the process flow 100 described and/or contemplated herein in connection with FIG. 1, any one or more of the embodiments of the process flow 200 described and/or contemplated herein in connection with FIG. 2, and/or any one or more of the embodiments of the system 300 described and/or contemplated herein in connection with FIG. 3.

### Account Reserve Interface

FIG. 4 presents a graphical user interface (GUI) 400 of an account reserve service 410 associated with an account, in accordance with some embodiments of the invention. As used with respect to FIGS. 4 and 5, an “apparatus” is an apparatus that may be configured to perform various portions of the processes 100 and 200. When the user authenticates himself/herself into an account associated with the user, the apparatus may present a user with an account reserve service option 410. In some embodiments, the apparatus may present the account reserve service option 410 to the user only if the user qualifies for the account reserve service option 410. In order to use the account reserve service option, the user may select the account reserve service option 410 using any acceptable form of input (e.g., mouse click, touch, voice input, etc.). Subsequently, the apparatus may present a table 420 that illustrates the transaction history associated with the account. The example transactions presented in FIG. 4 may be the four most recent transactions associated with the account. Alternatively, the list of transactions may be sorted by transaction name, transaction identification number (ID), amount of transaction, transaction type, etc.

The apparatus allows a user to select a transaction. In the example interface of FIG. 4, the user, at 421, selects “ABC Cleaners” transaction as a transaction for which the apparatus may cause the reserve to hold currency. Additionally, the apparatus may allow a user to define an amount associated with a selected transaction at 422. If the user does not define an amount at 422, then the apparatus uses the amount shown in 411 as the amount associated with the transaction. For instance, the amount at 425 is $435. Additionally, the apparatus allows a user to select a transaction type associated with a transaction at 423. As explained earlier, when the user selects a transaction type associated with the transaction, one or more future transactions of the same transaction type (e.g., dry cleaner transactions) may be satisfied using currency from the reserve. The apparatus also displays at 424 the total amount of currency to hold in the reserve, where the total is generated based at least partially on the user's selections.

At 430, the user may also enter a maximum reserve amount. As explained earlier, if the total of the amounts in the “Select Amount” column for all the selected transactions exceeds the maximum reserve amount defined at 430, then the apparatus proportionately decreases the reserve amount associated with each selected transaction. The apparatus may also present an option at 435 (e.g., a menu, an icon, a digital button, etc.), and when the option is selected by the user, the apparatus establishes the reserve. The apparatus may also present an option at 440 (e.g., a menu, an icon, a digital button, etc.), and when the option is selected by the user, the apparatus automatically analyzes the transaction history and generates an amount of currency to hold in the reserve. The result of this automatic generation of a reserve amount is display in FIG. 5.

FIG. 5 presents a graphical user interface (GUI) 500 of an account reserve service associated with an account, in accordance with other embodiments of the invention. In the embodiment presented in FIG. 5, the apparatus has automatically generated an account reserve.

The transactions presented in FIG. 5 are transactions that have been automatically selected by the apparatus based on one or more conditions of eligibility. Therefore, the “Select Transaction” option has been ‘checked’ (i.e., selected) for each of the selected transactions. However, the apparatus may allow a user to ‘uncheck’ a selected transaction. Therefore, a user may uncheck 521. The apparatus also automatically fills in amounts associated with each transaction in the “Select Amount” column. The apparatus may allow a user to modify these amounts; therefore, in some embodiments, the user may change the amount at 522. The apparatus also ‘checks’ transaction types that are automatically selected by the apparatus. Therefore, in the embodiment presented in FIG. 5, the apparatus automatically ‘checks’ a utilities payment transaction type at 523. Therefore, any future transaction that is associated with a utilities payment transaction type may be satisfied using currency from the reserve. The apparatus may also allow a user to ‘uncheck’ transaction types that are automatically selected by the apparatus. Therefore, at 523, a user may ‘uncheck’ the ‘transaction type’ selection associated with utilities payments.

The apparatus also displays at 524 the total amount of currency to hold in the reserve, where the total is generated based at least partially on the apparatus' automatic selections. If a user ‘unchecks’ a selected transaction or changes the amount associated with a selected transaction, the total displayed at 524 is dynamically updated to reflect the user's changes.

At 530, the user may also enter a maximum reserve amount. As explained earlier, if the total of the amounts in the “Select Amount” column for all the selected transactions exceeds the maximum reserve amount defined at 530, then the apparatus proportionately decreases the reserve amount associated with each selected transaction. The apparatus may also present an option 540 (e.g., a menu, an icon, a digital button, etc.), and when the option is selected by the user, the apparatus establishes the reserve.

In some embodiments, the apparatus may also present in a pictorial format (e.g., a chart such as a pie chart or a bar chart) the amount of remaining currency in the reserve. Therefore, when a user accesses a user's banking homepage (e.g., electronic banking, mobile banking, etc.), an apparatus presents a pictorial representation of the amount of remaining currency in the reserve. The apparatus may also present the pictorial representation on the user's social network homepage. The visual presentation may allow a user to monitor the amount of currency remaining in the reserve. The constant monitoring may allow a user to reduce the number and/or amount associated with transactions that are eligible to be satisfied using currency from the reserve. Alternatively or additionally, the constant monitoring may allow a user to transfer currency into the reserve if the user determines that the amount of currency in the reserve is insufficient to satisfy transactions that are eligible to be satisfied using currency from the reserve.

Thus, present embodiments disclosed in detail above provide systems, methods and computer program products for managing currency in an account using a reserve, where the reserve holds currency associated with an account.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” For example, various embodiments may take the form of web-implemented computer software. Furthermore, embodiments of the present invention may take the form of a computer program product on a computer-readable medium having computer-executable program code embodied in the medium.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein above with reference to flowchart illustrations and/or block diagrams of apparatuses and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

As used herein, a processor/computer, which may include one or more processors/computers, may be “configured to” perform a stated function in a variety of ways, including, for example, by having one or more general-purpose circuits perform the stated function by executing one or more computer-executable program code portions embodied in a computer-readable medium, and/or by having one or more application-specific circuits perform the stated function.

While the foregoing disclosure discusses illustrative embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any embodiment may be utilized with all or a portion of any other embodiment, unless stated otherwise.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A method for managing an account, the method comprising:
receiving at a computing device information associated with the account;
determining, via a computing device processor, a selected amount of currency from the account to hold in a reserve associated with the account, based at least partially on the information; and
indicating the selected amount of currency to hold in the reserve.

2. The method of claim 1, wherein the determining further comprises:
determining the selected amount to hold in the reserve based at least partially on transaction history associated with the account.

3. The method of claim 1, wherein the determining further comprises:
determining the selected amount to hold in the reserve based at least partially on one or more financial transactions associated with the account as selected by a user.

4. The method of claim 3, wherein the user defines an amount associated with a financial transaction, and selects a number of instances of the financial transaction to be satisfied using currency from the reserve.

5. The method of claim 1, wherein the determining further comprises:
determining the selected amount to hold in the reserve based at least partially on a suggested value for the amount to hold in the reserve received from a user.

6. The method of claim 1, wherein the determining further comprises:
determining the selected amount to hold in the reserve based at least partially on a sum of amounts associated with one or more eligible financial transactions associated with the account.

7. The method of claim 6, wherein an eligible financial transaction is a recurring transaction.

8. The method of claim 7, wherein an amount associated with the eligible financial transaction is an average amount associated with one or more instances of the eligible financial transaction during a predetermined period of time.

9. The method of claim 7, wherein an amount associated with the eligible financial transaction is a maximum amount associated with the eligible financial transaction during a predetermined period of time.

10. The method of claim 6, wherein an amount associated with an eligible financial transaction can satisfy one or more instances of the eligible financial transaction.

11. The method of claim 6, wherein the eligible financial transaction is of a predetermined transaction type.

12. The method of claim 11, wherein the transaction type is a merchant category code.

13. The method of claim 6, wherein the determining further comprises:
proportionately decreasing an amount associated with an eligible financial transaction based at least partially on a predetermined maximum amount of currency that the reserve can hold.

14. The method of claim 6, further comprising:
automatically altering the selected amount to hold in the reserve based at least partially on determining a change in the one or more eligible financial transactions.

15. The method of claim 1, further comprising:
sending an alert when an amount of currency in the reserve decreases to a trigger amount.

16. The method of claim 1, further comprising:
posting, to a social network, information associated with the reserve.

17. The method of claim 1, wherein the currency can be released from the reserve during a predetermined period of time.

18. The method claim 1, further comprising:
automatically transferring currency from a non-reserve to the reserve if an amount of currency in the reserve decreases to a trigger amount.

19. The method of claim 1, wherein the selected amount of currency is transferred to the reserve, wherein the reserve is a separate account from the account.

20. The method of claim 1, wherein the account is associated with a plurality of reserves.

21. An apparatus for managing an account, the apparatus comprising:
a memory;
a processor; and
a module stored in the memory, executable by the processor, and configured to:
receive information associated with the account;
determine, based at least partially on the information, a selected amount of currency from the account to hold in a reserve associated with the account; and
indicate the selected amount of currency to hold in the reserve.

22. The apparatus of claim 21, wherein the module configured to determine is further configured to:
determine the selected amount to hold in the reserve based at least partially on transaction history associated with the account.

23. The apparatus of claim 21, wherein the module configured to determine is further configured to:
determine the selected amount to hold in the reserve based at least partially on one or more financial transactions associated with the account as selected by a user.

24. The apparatus of claim 23, wherein the user defines an amount associated with a financial transaction, and selects a number of instances of the financial transaction to be satisfied using currency from the reserve.

25. The apparatus of claim 21, wherein the module configured to determine is further configured to:
determine the selected amount to hold in the reserve based at least partially on a suggested value for the amount to hold in the reserve received from a user.

26. The apparatus of claim 21, wherein the module configured to determine is further configured to:
determine the selected amount to hold in the reserve based at least partially on a sum of amounts associated with one or more eligible financial transactions associated with the account.

27. The apparatus of claim 26, wherein an eligible financial transaction is a recurring transaction.

28. The apparatus of claim 27, wherein an amount associated with the eligible financial transaction is an average amount associated with one or more instances of the eligible financial transaction during a predetermined period of time.

29. The apparatus of claim 27, wherein an amount associated with the eligible financial transaction is a maximum amount associated with the eligible financial transaction during a predetermined period of time.

30. The apparatus of claim 26, wherein an amount associated with an eligible financial transaction can satisfy one or more instances of the eligible financial transaction.

31. The apparatus of claim 26, wherein the eligible financial transaction is of a predetermined transaction type.

32. The apparatus of claim 31, wherein the transaction type is a merchant category code.

33. The apparatus of claim 26, wherein the module configured to determine is further configured to:
proportionately decrease an amount associated with an eligible financial transaction based at least partially on a predetermined maximum amount of currency that the reserve can hold.

34. The apparatus of claim 26, wherein the module is further configured to:
automatically alter the selected amount to hold in the reserve based at least partially on determining a change in the one or more eligible financial transactions.

35. The apparatus of claim 31, wherein the module is further configured to:
send an alert when an amount of currency in the reserve decreases to a trigger amount.

36. The apparatus of claim 31, wherein the module is further configured to:
post, to a social network, information associated with the reserve.

37. The apparatus of claim 31, wherein the module is configured to release currency from the reserve during a predetermined period of time.

38. The apparatus claim of 31, wherein the module is further configured to:
automatically transfer currency from a non-reserve to the reserve if an amount of currency in the reserve decreases to a trigger amount.

39. The apparatus of claim 31, wherein the module is configured to transfer the selected amount of currency to the reserve, wherein the reserve is a separate account from the account.

40. The apparatus of claim 31, wherein the account is associated with a plurality of reserves.

41. A computer program product for managing an account, the computer program product comprising:
a non-transitory computer-readable medium comprising a set of codes for causing a computer to:
receive information associated with the account;
determine, based at least partially on the information, a selected amount of currency from the account to hold in a reserve associated with the account; and
indicate the selected amount of currency to hold in the reserve.

42. The computer program product of claim 41, wherein the set of codes that causes a computer to determine further causes a computer to:
determine the selected amount to hold in the reserve based at least partially on transaction history associated with the account.

43. The computer program product of claim 41, wherein the set of codes that causes a computer to determine further causes a computer to:
determine the selected amount to hold in the reserve based at least partially on one or more financial transactions associated with the account as selected by a user.

44. The computer program product of claim 43, wherein the user defines an amount associated with a financial transaction, and selects a number of instances of the financial transaction to be satisfied using currency from the reserve.

45. The computer program product of claim 41, wherein the set of codes that causes a computer to determine further causes a computer to:
determine the selected amount to hold in the reserve based at least partially on a suggested value for the amount to hold in the reserve received from a user.

46. The computer program product of claim 41, wherein the set of codes that causes a computer to determine further causes a computer to:
determine the selected amount to hold in the reserve based at least partially on a sum of amounts associated with one or more eligible financial transactions associated with the account.

47. The computer program product of claim 46, wherein an eligible financial transaction is a recurring transaction.

48. The computer program product of claim 47, wherein an amount associated with the eligible financial transaction is an average amount associated with one or more instances of the eligible financial transaction during a predetermined period of time.

49. The computer program product of claim 47, wherein an amount associated with the eligible financial transaction is a maximum amount associated with the eligible financial transaction during a predetermined period of time.

50. The computer program product of claim 46, wherein an amount associated with an eligible financial transaction can satisfy one or more instances of the eligible financial transaction.

51. The computer program product of claim 46, wherein the eligible financial transaction is of a predetermined transaction type.

52. The computer program product of claim 51, wherein the transaction type is a merchant category code.

53. The computer program product of claim 46, wherein the set of codes that causes a computer to determine further causes a computer to:
proportionately decrease an amount associated with an eligible financial transaction based at least partially on a predetermined maximum amount of currency that the reserve can hold.

54. The computer program product of claim 46, wherein the set of codes further causes a computer to:
automatically alter the selected amount to hold in the reserve based at least partially on determining a change in the one or more eligible financial transactions.

55. The computer program product of claim 51, wherein the set of codes further causes a computer to:
send an alert when an amount of currency in the reserve decreases to a trigger amount.

56. The computer program product of claim 51, wherein the set of codes further causes a computer to:
post, to a social network, information associated with the reserve.

57. The computer program product of claim 51, wherein the set of codes causes a computer to release currency from the reserve during a predetermined period of time.

58. The computer program product of claim 51, wherein the set of codes further causes a computer to:
automatically transfer currency from a non-reserve to the reserve if an amount of currency in the reserve decreases to a trigger amount.

59. The computer program product of claim 51, wherein the set of codes causes a computer to transfer the selected amount of currency to the reserve, wherein the reserve is a separate account from the account.

60. The computer program product of claim 51, wherein the account is associated with a plurality of reserves.
